(19) United States
(12) Patent Application Publication
(10) Pub. No.: US 2003/0130010 A1
(43) Pub. Date: Jul. 10, 2003

(54) Cable tray and ladder mounting for cellular base station receive and transmit link enhancement

(75) Inventors: Richard L. Monroe, Norco, CA (US); David R. Chase, Santa Barbara, CA (US)

Correspondence Address: O'MELVENY & MEYERS, 114 PACIFICA, SUITE 100, IRVINE, CA, 92618, US

(73) Assignee: Superconductor Technologies, Inc.

(21) Appl. No.: 10/041,217

(22) Filed: Jan. 7, 2002

(51) Int. Cl. H04B 1/08

(52) U.S. Cl. 455/561; 455/560; 455/347

(57) ABSTRACT

Device mounting apparatuses suitable for coupling to a cable ladder of a cell-site, and to house a device or devices within the cell-site are provided. In one embodiment, the apparatus includes a plurality of first brackets capable of being coupled to the cable ladder, and a plurality of second brackets capable of being coupled to both the first brackets and to the device or devices. The first bracket is a substantially Z-shaped bracket, and the second bracket is a substantially U-shaped bracket. In another embodiment, a device mounting apparatus a plurality of vertical members and horizontal members coupled to at least two vertical members. The apparatus is configured to accept and secure a device within the space defined by the vertical members, the horizontal members, and the rails of the cable ladder. Methods for mounting a device inside a cell-site using the apparatuses of the present invention are also provided.

### FIELD OF THE INVENTION

The present invention relates generally to cellular telephone base stations and, more particularly, to systems and methods for mounting and storing devices in a cellular telephone base station.

### BACKGROUND

A cellular telephone base station, or cell-site, incorporates a multi-channel two-way radio that receives signals from, and sends signals to, cellular phones located near the cell-site. All references to cellular phones herein are also intended to encompass PCS phones and other mobile phones. Also, “cellular telephone base station” and “cell-site” will be used interchangeably herein. After receiving a signal from a cellular phone, the cell-site relays the signal to a regular land line phone system. Similarly, the cell-site transmits signals received from the regular land line to the surrounding cellular phones.

A typical cell-site installation 10 is illustrated in FIG. 1. The cell-site 10 includes an antenna or a plurality of antennas 12 mounted on a tower or mast 14. A station located at the base of the tower houses the electronic devices necessary to process the signals received and transmitted by the cell-site. This electronic devices may include, for example, a duplexer 16, a radio frequency (RF) filter 18, a multicoupler 20, a linear power amplifier 22, a transceiver 24, and a base station switch 26. In the cell-site installation 10 of FIG. 1, two racks 28, 30 are located within the site. As shown, the duplexer 16, RF filter 18, and multicoupler 20 are stored in one rack 28, while the linear power amplifier 22 is stored in the other rack 30. A cable 32 connects the antenna 12 to the electronic devices inside the cell-site. Typically, the cable 32 is run through the cell-site bulkhead 34 and must extend for an additional 10 to 40 feet inside the cell-site in order to connect with the electronic devices previously discussed. The requirement of a 10 to 40 foot cable run inside the cell-site, which is necessary in current cell-site installations, results in a loss of signal strength.

When adding additional devices in a cell-site, there is oftentimes no additional space in the rack installed within the cell-site. As noted, cell-site installations typically include at least one rack inside the cell-site for the storage of electronic devices used to process cellular telephone signals. As additional electronic devices are added to the base station, to accommodate advances in signal processing technology, for example, the space available in the racks located within the cell-site is reduced. Exacerbating this problem is the limited space inside each cell-site. For space efficiency purposes, cell-sites are generally small in size. Consequently, due to the space constraints within each cell-site, it is generally not practical, or possible, to place a large number of racks inside a cell-site in order to increase the rack storage space therein.

An alternative is to mount some of the devices, such as a RF filter, on the tower or mast itself. This is, however, not always a convenient or available option.

Those skilled in the art have failed to provide for a cell-site installation that reduces the length of cable required to connect the antennas to the electronic devices stored inside the cell-site. As a result, those skilled in the art have failed to provide for a cell-site installation that reduces the signal loss from the cable connecting the antennas to the electronic devices. Those skilled in the art have also failed to provide for systems and methods for storing electronic devices within a cell-site in a space efficient manner.

An analogous system to a cell-site is a system for transmitting and receiving RF signals, for communicating with a global computer network, that is installed within a retail establishment, such as, e.g., a cafe, an office, or a residence. For example, such a system may be installed within a coffee house in order to enable the patrons of the coffee house to access the internet while at the coffee house. Typically, these systems include an antenna installed on an exterior surface of the building, and related communications equipment, which may include an amplifier, a transceiver, and the like, is placed inside the building. As with the cell-site previously discussed, issues related to the storage of the communications equipment within the building, such as, e.g., where to locate the equipment and clearing space within the building for the equipment, often arise. Those skilled in the art have failed to provide for a space efficient solution to store this equipment that also reduces the amount of signal loss in the cables connecting the equipment to the antenna.

### SUMMARY OF THE INVENTION

The present invention is directed to improved apparatuses and methods for mounting devices within a cell-site. The apparatuses and methods of the present invention minimize the amount of cable required to connect antenna feed-lines to devices within the cell-site, thereby reducing the amount of signal degradation from an antenna to that device, as well as maximize the use of space within the cell-site.

The present invention provides for device mounting apparatuses suitable for coupling to a cable tray or ladder of a cell-site, and to house a device within the cell-site. In one embodiment, the apparatus includes a plurality of first brackets capable of being coupled to the cable ladder, and a plurality of second brackets. The second brackets are capable of being coupled to both the first brackets and to the device or devices intended for storage within the apparatus, and ultimately within the cell-site. Each first bracket includes a first surface that is adapted to engage the second bracket, and also includes a second surface that is adapted to be secured to the cable ladder. The second surface of each first bracket has a plurality of slots, and the apparatus further includes bolts for insertion through each slot and attachment elements to engage an end of a bolt and, upon tightening, to secure each first bracket to the cable ladder. The second bracket is also engageable to the device using a plurality of bolts or other suitable attachment elements. In one embodiment, the first bracket is a substantially Z-shaped bracket, and the second bracket is a substantially U-shaped bracket. The apparatus is also capable of being coupled to the cable ladder in a variety of configurations. In one configuration, the apparatus is affixed to the cable ladder such that the second brackets, i.e., the U-shaped brackets, are positioned substantially perpendicular to the rails of the cable ladder. In another configuration, the second brackets are positioned substantially parallel to the rails of the cable ladder.

Additionally, the present invention provides a device mounting apparatus for coupling to a cable ladder of a cell-site that includes a plurality of vertical members. Each vertical member has a first end and a second end. The first end of each vertical member is secured to a rail of the cable ladder. The apparatus further includes a plurality of horizontal members. Each horizontal member is coupled to at least two vertical members, and at the second end of each respective vertical member. The apparatus is configured to accept and secure a device within the space defined by the vertical members, the horizontal members, and the rails of the cable ladder. In one embodiment, four vertical members are provided. In this embodiment, two of the vertical members are secured to a first rail of the cable ladder and the other two vertical members are secured to the opposite, second rail of the cable ladder. Each horizontal member, in this embodiment, is coupled to a vertical member on the first and second rails of the cable ladder, wherein the vertical members are substantially parallel to each other. In another embodiment, a first horizontal member is coupled to the vertical members that are affixed to a first rail of the cable ladder, and a second horizontal member is coupled to the vertical members affixed to the opposite, second rail of the cable ladder.

The present invention also provides a method for mounting a device inside a cell-site such that the length of the cable run required to connect the device to an antenna feed-line is minimized. A plurality of first brackets is coupled to a cable ladder inside the cell-site. The cable ladder to which the first brackets are coupled is preferably the cable ladder nearest in proximity to the entry point of antenna feed-cables or feed-lines in the bulkhead of the cell-site. A second bracket is then coupled to each first bracket. In one configuration, the second bracket is coupled to the first bracket such that the second bracket is oriented substantially parallel to the rails of the cable ladder. In another configuration, the second bracket is coupled to the first bracket such that the second bracket is orient substantially perpendicular to the rails of the cable ladder. Subsequently, a device, or devices, is secured to the second bracket. In one embodiment, the first brackets are substantially Z-shaped brackets, and the second brackets are substantially U-shaped brackets.

Other objects and features of the present invention will become apparent from consideration of the following description taken in conjunction with the accompanying drawings.

### DESCRIPTION OF THE DRAWINGS

FIG. 1 is an illustration of a cellular telephone base station, or cell-site.

FIG. 2 is an illustration of a cell-site implementing the apparatus and methods of the present invention.

FIG. 3a is an illustration of a tray mount of the present invention.

FIG. 3b is an illustration of another embodiment of a tray mount of the present invention.

FIG. 4 is an illustration of an alternative configuration of the tray mount illustrated in FIG. 3a.

FIG. 5 is an illustration of another tray mount of the present invention.

FIG. 6 is a detail of the tray mount of FIG. 5, showing the securing of the vertical and horizontal members of the tray mount.

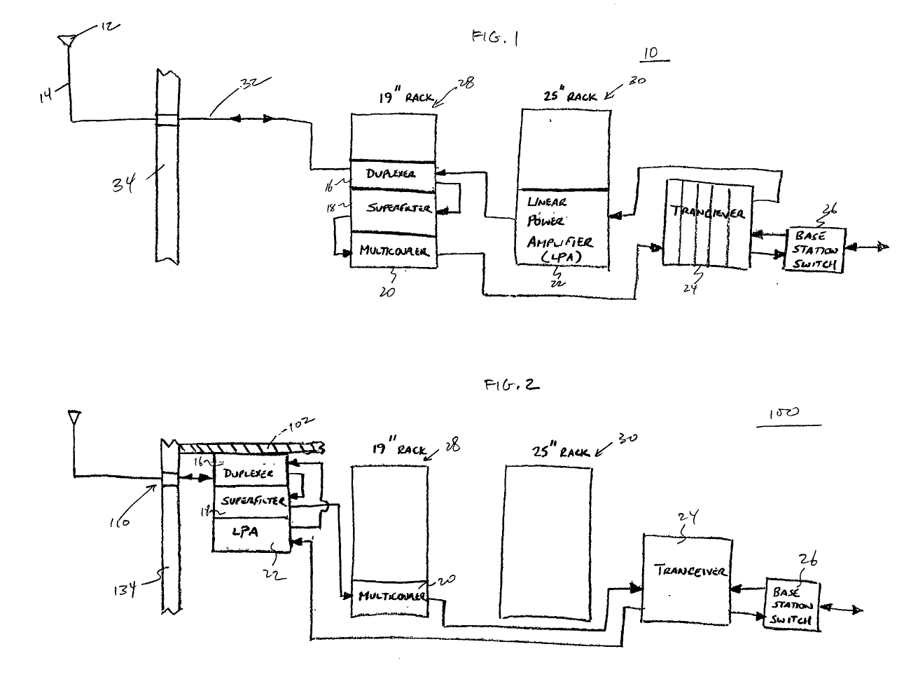

### DETAILED DESCRIPTION

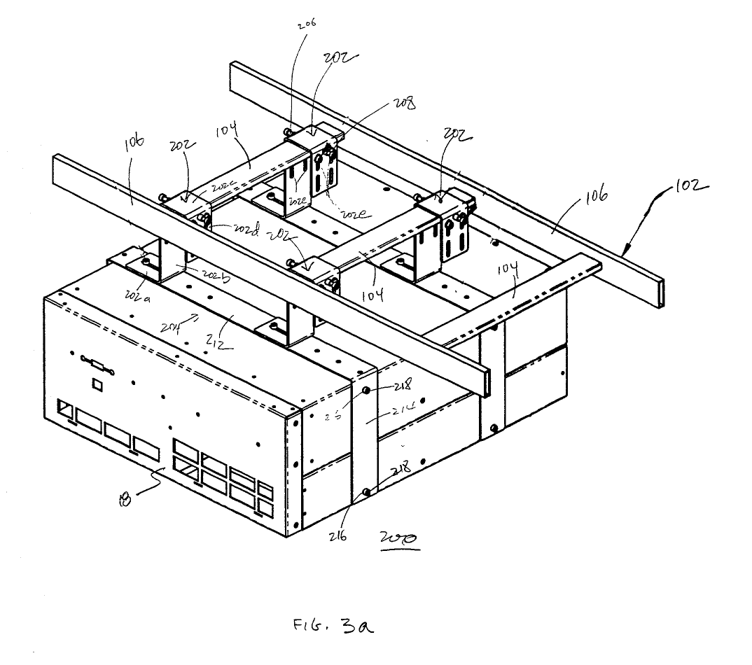

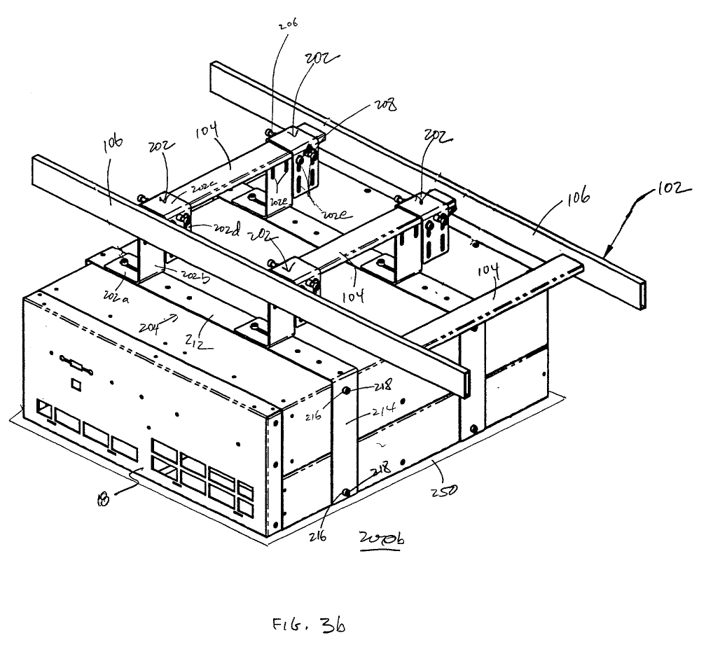

Illustrated in FIG. 2 is a cell-site installation 100 implementing the present invention. The cell-site 100 includes electronic devices that are stored within the cell-site 100 without requiring racks, though, in alternative embodiments, racks may be used to provide additional storage space for some devices and components. This is in contrast to typical cell-sites where electronic devices are mounted or stored within racks exclusively. In a preferred embodiment, a tray mount 200 (see FIG. 3a) is provided within the cell-site 100. The tray mount 200 is preferably coupled to a horizontal support structure within the cell-site 100. For example, in one preferred embodiment, as seen in FIG. 3a, the tray mount 200 is secured to one of the cable ladders 102 within the cell-site 100. Additionally, the tray mount 200 is preferably coupled to the cable ladder 102 that is proximate to the area 110 of the bulkhead 134 where the antenna feed-lines enter the cell-site 100. Due to the placement of the tray mount 200 in close proximity to the area 110 of the bulkhead 134 where the feed-lines enter the cell-site 100, the amount of cable length needed to connect the feed-lines to the devices, which may include a duplexer 16, a RF filter 18, and a linear power amplifier 22, stored in the tray mount 200 is minimized. In one embodiment, the tray mount 200 is mounted within the cell-site 100 so that only 0 to 10 feet, and more preferably 0 to 5 feet, of cable is necessary to connect the feed-lines to the devices on the tray mount 200. Compared with the typical 10 to 40 feet of cable required in the cell-site installations known in the art, the minimal amount of cable required when using the tray mount 200 of the present invention minimizes the loss in signal strength of RF signals transmitted to and from the devices on the tray mount 200. Preferably, a minimal amount of cable is utilized such that the loss in signal strength is substantially reduced. For example, using the tray mount 200 to reduce 40 feet of 12 inch flexible cable from an installation, at 800 MHz, results in an elimination of 1.268 dB of loss. Placing a device or a plurality of devices within the tray mount 200 also increases the available storage space in any racks within the cell-site 100, such as, e.g., racks 28 and 30, if those racks are provided within the cell-site 100.

FIG. 3a is an illustration of one embodiment of a tray mount, tray mount 200, of the present invention. Tray mount 200 is shown in operation, i.e., coupled to a cable ladder 102. In alternative embodiments, the tray mount 200 is secured to pipes or other mechanically secure points of attachment within the cell-site 100 that are in close proximity to the bulkhead 134. The cable ladder 102 typically includes a set of rails 106 with a plurality of members 104, or steps, spanning opposite rails 106. In the embodiment shown in FIG. 3a, a RF filter 18 is connected to the tray mount 200. It should be appreciated, however, that more than one device may be connected to a tray mount 200 and other types of electronic devices that would typically be stored within a cell-site may also be secured to the tray mount 200, as will be apparent from the following description.

Tray mount 200 includes a first set of brackets 202. The first brackets 202 are configured for coupling to the cable ladder 102. Each first bracket 202 is preferably manufactured from a material that is sufficiently strong to support the weight of the other components of the tray mount 200, which will be discussed herein, as well as a device or a plurality of devices secured to the tray mount 200. Exemplary materials from which the first brackets 202, as well as the other parts of the tray mount 200, may be manufactured include steel, aluminum, and the like. In a preferred embodiment, a plurality of first brackets 202 is coupled to the members 104 of the cable ladder 102. The tray mount 200 of shown in FIG. 3a includes a pair of first brackets 202 in operable connection to a pair of members 104, with one pair of first brackets 202 being coupled to a respective member 104. Alternatively, a larger number of first brackets 202 is coupled to any single member 104. Also, in another embodiment, the first brackets 202 of the tray mount 200 are coupled to more than two members 104 of the cable ladder 102. The first brackets 202, in the embodiment shown in FIG. 3a, are substantially Z-shaped members. An exemplary first bracket 202 of the embodiment in FIG. 3a includes a first portion 202a adapted for engaging a second bracket 204 (discussed herein) of the tray mount 200 and for engaging, through the second bracket 204, a device coupled to the tray mount 200, such as, e.g., the RF filter 18 shown in FIG. 3a. A second portion 202c is adapted for placement on a member 104 of the cable ladder 102. The second portion 202c, in the illustrated embodiment, is configured to lay flat on member 104 when the tray mount 200 is engaged to the cable ladder 102. Additionally, the first bracket 202 includes a first projection 202b and a second projection 202d, with the first projection 202b connecting the first portion 202a and the second portion 202c of bracket 202. The second portion 202d extends from the opposite end of the second portion 202c as the first projection 202b and is substantially parallel to the first projection 202b. The first and second portions 202b, 202d also include a plurality of slots 202e. A slot on the first portion 202b is preferably in alignment with a slot on the second portion 202d.

To secure a first bracket 202 to, for example, a member 104 of the cable ladder 102, the first bracket 202 is placed over the member 104 such that the second portion 202c of the bracket 202 lays substantially flat on the member 104. When the second portion 202c is substantially flat on the member 104, the slots 202e on the first and second projections 202b, 202d are preferably in alignment. A suitable first attachment element, such as, e.g., a bolt 206, is threaded through aligned slots on the first and second projections 202b, 202d. An second attachment element that is capable of being coupled with the first attachment element, such as, e.g., a matching nut 208, is then tightened onto the bolt 206 in order to secure the first bracket 202 in place over the member 104. In the embodiment shown in FIG. 3a, two sets of bolts 206 and nuts 208 are used to secure each first bracket 202 to a member 104. In other embodiments, a greater or lesser number of sets of bolts 206 and nuts 208 are utilized to secure each first bracket 202. For example, a greater number of sets of bolts 206 and nuts 208 is desirable when a plurality of devices are stored in the tray mount 200, or when the device or devices are of a combined weight that requires a greater number of bolts 206 and nuts 208 to ensure the secure engagement of the tray mount 200 to the cable ladder 102.

The first brackets 202 of the tray mount 200 are further affixed to second brackets 204. The second brackets 204 are used to securably engage a device, or a plurality of devices, that would normally be stored and positioned in equipment racks within a base station. In the embodiment illustrated in FIG. 3a, the second brackets 204 are substantially U-shaped components having a first portion 212 and a plurality of attachment projections 214 extending from the ends of the first portion 212. The first portion 212 is preferably oriented in a parallel plane relative to the cable ladder 102. The first portion 212 is also coupled to the first portion 202a of a first bracket 202 using a suitable attachment element, such as, e.g., a bolt or a screw. The attachment element used to affix the first portion 202a of the first bracket 202 to the first portion 212 of the second bracket 204 also extends through the second bracket 204 to secure a device to which the tray mount 200 is engaged. In the embodiment of the tray mount 200 shown in FIG. 3a, each second bracket 212 is coupled to first brackets 202 that are in turn coupled to at least two different members 104 of the cable ladder 102. When coupled to first brackets 202 on different members 104, the second bracket 212 is preferably oriented in a parallel plane relative to the rails 106 of the cable ladder 102.

The attachment projections 214 of the second bracket 212 preferably extend perpendicularly relative to the first portion 212. Further, the attachment projections 214, when the second bracket 212 placed in operable connection with the first brackets 202, project away from the cable ladder 102. The attachment projections 214 include attachment points 216 configured for the insertion therethrough of a screw 218. In operation, a screw 218 is threaded through an attachment point 216 and further into the chassis of a device engaged by the tray mount 200 to securably affix the device to the tray mount 200. As shown, tray mount 200 includes two attachment points 216 on each attachment projection 214. A greater, or lesser, number of attachment points 216 is capable of being implemented on other embodiments of the tray mount 200.

As illustrated, tray mount 200 is configured to engage one device, in this case a RF filter 18. In other embodiments of the tray mount 200, the second brackets 204 are adapted for engagement of more than one device. In those embodiments, the attachment projections 214 are of sufficient lengths to accommodate the desired number of devices. For example, in an embodiment of the tray mount 200 suitable for engaging two devices, the lengths of the attachment projections 214 are substantially equivalent to the combined heights of the two devices desired to stored within the mount 200. Additional attachment points 216 are also located on the additional length of the attachment projection 214 in order to enable the addition devices to be securably affixed to the second bracket 204.

FIG. 3b illustrates another embodiment of the present invention, tray mount 200b. Tray mount 200b includes substantially the same components as tray mount 200. Therefore, the common elements between tray mount 200b and tray mount 200 are identically numbered in FIG. 3b, and reference is made to the description of tray mount 200 for those elements. In addition to the common elements with tray mount 200, the tray mount 200b further includes a platform 250. The platform 250 is secured to the ends of the attachment projections 214 using a suitable means, such as, e.g., screws, bolts, adhesives, welding, and the like. The platform 250 is also made from a material sufficient to support a device, such as, e.g., steel, metal, or hardened plastic. The platform 250 provides additional support for a device stored within the tray mount 200b.

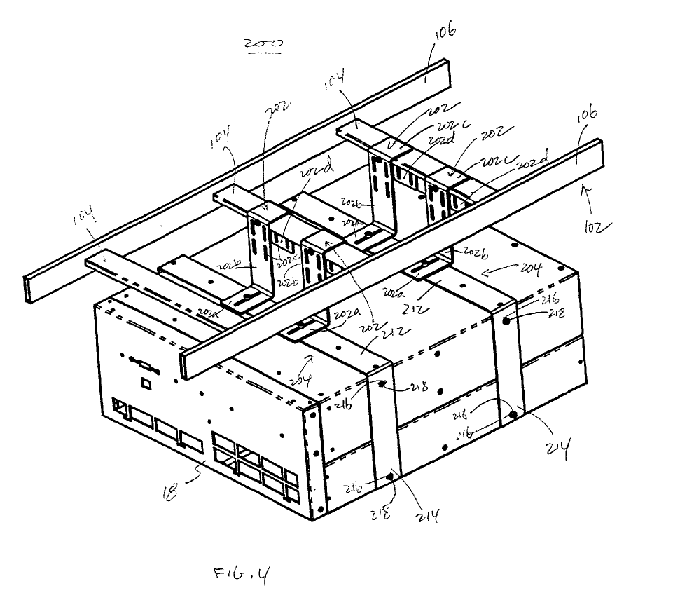

Turning back to FIG. 3a, the tray mount 200 is oriented such that the second brackets 204 are perpendicular to the members 104, and parallel to the rails 106, of the cable ladder 102. FIG. 4 illustrates an alternative configuration for the tray mount 200. Specifically, the tray mount 200 is also capable of being oriented such that the second brackets 204 are perpendicular to the rails 106 and parallel to the members 104 of the cable ladder 102. Here, the second brackets 204 are coupled to first brackets 202 that are affixed to the same member 104. In practice, the orientation of the tray mount 200 relative to the cable ladder 102 is chosen to minimize the length of cable required to travel from the antenna feed-lines entering the bulkhead 134 of the cell-site to the device or devices stored within the tray mount 200.

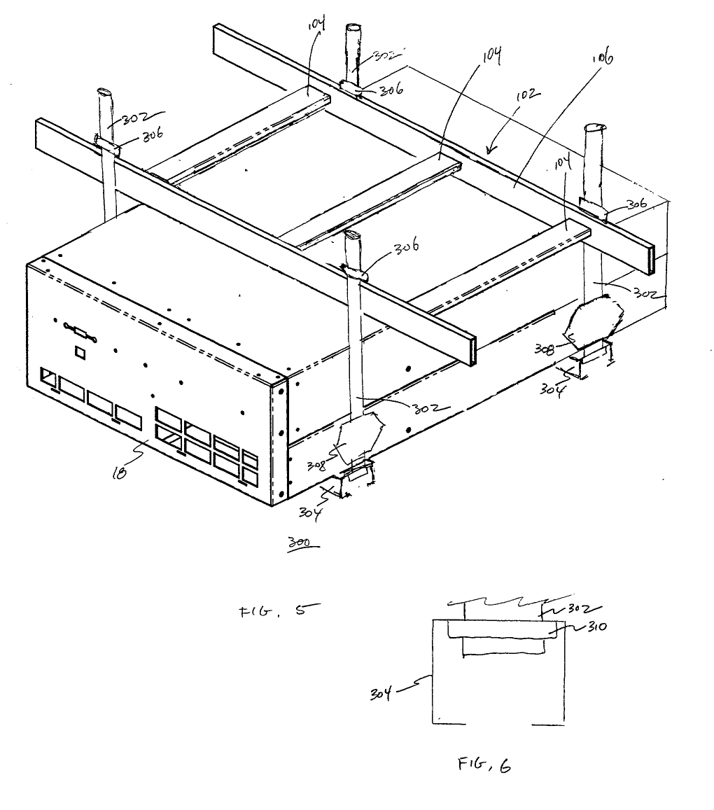

FIG. 5 illustrates another embodiment of the present invention, tray mount 300. The tray mount 300 includes a plurality of vertical members 302 that are placed adjacent a rail 106 of the cable ladder 102 when the tray mount 300 is in operation. In the embodiment illustrated in FIG. 5, four vertical members 302 are provided. In one embodiment, the vertical members 302 are generally elongated rods. A plurality of horizontal members 304 are also provided. The vertical members 302 and horizontal members 304 are constructed from a material that is sufficiently strong to support a device or devices secured to the tray mount 300, such as, e.g., steel, iron, a metallic material, or the like.

Each horizontal member 304 is placed in operable connection with vertical members 302 that are adjacent the same rail 106. As shown in FIG. 5, two vertical members 302 are coupled to one horizontal member 304. FIG. 6 is a detail of one manner of affixing a vertical member 302 to a horizontal member 304. In the embodiment shown in FIG. 6, the horizontal member 304 includes an opening (not shown) configured for the insertion of one end of the vertical member 302. Once the end of the vertical member 302 is inserted into the opening of the horizontal member 304, an attachment element 310 is engaged to the end of the vertical member 302 and tightened against the horizontal member 304 to hold the vertical member 306 in place. The attachment element 310 may be, for example, a nut, a screw, or the like. In one embodiment, the vertical member 306 and the attachment element 310 have cooperating threads.

Turning back to FIG. 5, the end of the vertical member 306 opposite the horizontal member 304 is engaged to the rail 106 of the cable ladder 102 using a suitable attachment element 306. A suitable attachment element 306 is, for example, a nut, a screw, or similar element that is adapted to be affixed to the end of the vertical member 306 and is capable of being tightened against the rail 106 in order to secure the vertical member 302 in place.

In one embodiment, a spacer 308 is attached to each vertical member 302. The spacer 308 is preferably located adjacent a device stored within the tray mount 300, such as, e.g., the RF filter 18 shown in FIG. 5. The spacer 308 stabilizes and prevents lateral movement of the device while it is located within the tray mount 300. The spacer 308 also minimizes the amount of external forces that are applied to the device. For example, when the spacer 308 is constructed from a rubber material, the spacer 308 is capable of absorbing a portion of the external forces that would otherwise act directly on the device within the tray mount 300.

The vertical members 302 are of sufficient length to provide an access opening for a device to be stored within the tray mount 300. For example, in the embodiment shown in FIG. 5, the length of a vertical member 302 is at least equivalent to the height of the device desired to be placed within the tray mount 300 and the height of the rail 106, in addition to an additional amount of length to allow the vertical member 302 to be secured by attachment element 306 to the rail 106 at one end and by attachment element 310 to the horizontal member 304 at the other end. In another embodiment of the tray mount 300, the vertical members 302 have a sufficient length to accommodate a plurality of devices stored within the tray mount 300. In operation, attachment elements 306 and 310 are tightened on both ends of the vertical members 302 such that a device, such as the RF filter 18 shown in FIG. 5, or a plurality of devices stacked atop each other, is tightly secured between the rails 106 of the cable ladder 102 and the horizontal members 304.

While the present invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A device mounting apparatus for coupling to a cable ladder of a cellular telephone cell-site, comprising:
a plurality of first brackets configured for coupling to the cable ladder, each first bracket having a first surface adapted to couple to a second bracket and a second surface to secure the first bracket to the cable ladder; and
a plurality of second brackets coupled to the first brackets, wherein the second brackets securably engage a device stored in the cell-site.

2. The device mounting apparatus of claim 1 wherein the second surface of each first bracket comprises a plurality of slots, and the device mounting apparatus further comprises:
a plurality of first attachment elements, each first attachment element configured for insertion into a slot; and
a plurality of second attachment elements, each second attachment element configured for coupling to the first attachment element, wherein the first attachment element is positioned to secure each respective first bracket to the cable ladder.

3. The device mounting apparatus of claim 1 wherein each first bracket is a substantially Z-shaped bracket.

4. The device mounting apparatus of claim 1 wherein each second bracket is a substantially U-shaped bracket.

5. A device mounting apparatus for coupling to a cable ladder of a cellular telephone cell-site, the cable ladder having two rails and a plurality of members disposed between the rails, the device mounting apparatus comprising:
a plurality of substantially Z-shaped brackets configured for coupling to the members of the cable ladder; and
a plurality of substantially U-shaped brackets configured for coupling to the Z-shaped brackets, wherein the U-shaped brackets securably engage a device stored in the cell-site.

6. The device mounting apparatus of claim 5 wherein each Z-shaped bracket comprises a first surface adapted for coupling to a U-shaped bracket and a second surface for coupling to a member of the cable ladder.

7. The device mounting apparatus of claim 6 wherein the second surface of each Z-shaped bracket comprises a plurality of slots, and the device mounting apparatus further comprises:
a plurality of first attachment elements, each first attachment element configured for insertion into a slot; and
a plurality of second attachment elements, each second attachment element configured for coupling to a first attachment element, wherein the first attachment element is positioned to secure each respective Z-shaped bracket to a member of the cable ladder.

8. The device mounting apparatus of claim 5 wherein the U-shaped brackets are positioned substantially parallel to the rails of the cable ladder.

9. The device mounting apparatus of claim 5 wherein the U-shaped brackets are positioned substantially perpendicular to the rails of the cable ladder.

10. The device mounting apparatus of claim 5 wherein each U-shaped bracket includes two attachment projections, and the apparatus further comprises a platform secured to the attachment projections of the U-shaped brackets.

11. The device mounting apparatus of claim 5 wherein the apparatus is mounted adjacent to a bulkhead of the cell-site.

12. A method for mounting a device inside a cellular telephone cell-site, comprising:
coupling a plurality of first brackets to a cable ladder inside the base site, the cable ladder being the cable ladder nearest in proximity to an entry point of antenna feed-cables in a bulkhead of the cell-site;
coupling a second bracket to each first bracket; and
securing a device to the second brackets.

13. The method of claim 12 wherein the first brackets are substantially Z-shaped brackets.

14. The method of claim 13 wherein each second bracket is substantially U-shaped.

15. The method of claim 12 wherein the cable ladder comprises two rails and a plurality of members between the rails, and wherein the second brackets are oriented substantially parallel to the rails.

16. The method of claim 15 wherein the cable ladder comprises two rails and a plurality of members between the rails, and wherein the second brackets are oriented substantially perpendicular to the rails.

17. A device mounting apparatus for coupling to a cable ladder of a cellular telephone cell-site, the cable ladder having rails and a plurality of members extending between two rails, the apparatus comprising:
a plurality of vertical members, each member having a first end and a second end, wherein each first end is coupled to a rail of the cable ladder; and
a plurality of horizontal members, each horizontal member coupled to at least two vertical members at the second end of the respective members;
wherein the apparatus is configured to accept a device in a space defined by the vertical members, the horizontal members, and the rails of the cable ladder.

18. The apparatus of claim 17 wherein the plurality of vertical members comprises four vertical members, and wherein two vertical members are coupled to a first rail of the cable ladder, and two vertical members are coupled to a second rail of the cable ladder, the first and second rails being in opposite relation.

19. The apparatus of claim 18 wherein each horizontal member is coupled to a vertical member on the first rail and to a vertical member on the second rail, the vertical members being substantially parallel.

20. The apparatus of claim 18 wherein the horizontal members comprise a first horizontal member and a second horizontal member, and wherein the first horizontal member is coupled to the vertical members on the first rail and the second horizontal member is coupled to the vertical members on the second rail.
